(19) United States
(12) Patent Application Publication
(10) Pub. No.: US 2016/0329847 A1
(43) Pub. Date: Nov. 10, 2016

(54) SYSTEM FOR CONTROLLING A GENERATOR SET

(71) Applicant: MOTEURS LEROY-SOMER, Angouleme (FR)

(72) Inventors: Emile MOUNI, L'Isle d'Espagnac (FR); Samuel MOSER, Gond-Pontouvre (FR); Patrice BETGE, L'Isle d'Espagnac (FR); Vincent MORISSEAU, Angouleme (FR)

(73) Assignee: MOTEURS LEROY-SOMER, Angouleme (FR)

(21) Appl. No.: 15/109,898

(22) PCT Filed: Jan. 5, 2015
(86) PCT No.: PCT/IB2015/050070

§ 371 Date: Jul. 6, 2016

(30) Foreign Application Priority Data
Jan. 6, 2014 (FR) 1450058

(51) Int. Cl. H02P 9/00; H02P 9/08

(52) U.S. Cl. CPC H02P 9/006; H02P 9/08

(57) ABSTRACT

A system for controlling and regulating a generating set including an alternator that is mechanically coupled to a drive motor, the alternator including a terminal box borne by a casing and containing electric connections connected to the windings of the alternator. The system includes a controller part for controlling the motor of the generating set and a regulator part for regulating an output voltage of the alternator, the voltage regulator part being positioned outside the terminal box and solidly connected to the controller part of the set.

The present invention relates to a system for the control and regulation of a generator set, and a generator set thus equipped.

A generator set comprises an assembly of a drive motor and an alternator. For the delivery of a rated voltage and frequency, the alternator is equipped with a voltage regulator, the main function of which is the maintenance of the output voltage of the alternator at a given setpoint value.

The voltage regulator may be realized in the form of one or more electronic circuit boards housed in a terminal box of the alternator, which is designed accordingly.

Known generator sets also comprise a unit controller, the function of which is to display all the thermal, electrical or mechanical parameters of the generator set and, on the one hand, to initiate the shutdown thereof if measured values lie outside predetermined limits and, on the other hand, to initiate the start-up thereof, either automatically or by the action of the user. This controller conventionally comprises a terminal box or control cabinet, situated at a different location from that of the voltage regulator.

US 2010/0241283 discloses a system for the control of a generator set comprising a motor control module which communicates with a voltage regulator on the alternator, in order to control the level of the electrical load on the generator set.

US 2011/0089911 describes a controller which communicates with a voltage regulator on an alternator of a generator set and an alternator start-up circuit, wherein the controller is designed to initiate start-up by the separate excitation of an alternator which has lost its remanent field. The generator set is controlled by a digital control system (DCS).

U.S. Pat. No. 6,555,929 B1 discloses a controller for a generator set which communicates with a voltage regulator on an alternator and a motor control module. The unit controller calculates operating parameters for the alternator and transmits command signals to the voltage regulator.

US 2004/007876 A1 describes a solution for the selective utilization of different generator sets on a network.

U.S. Pat. No. 5,390,068 discloses a system for the control of the voltage and speed of a generator set.

Moreover, in the majority of generator set controllers, speed of rotation is measured either by means of an MPU (magnetic pick-up), or by means of the alternator voltage. This speed measurement is critical for the purposes of the protection of the generator set.

The invention is intended to further improve systems for the control and regulation of a generator set, specifically in the interests of facilitating the integration of the alternator, reducing its footprint, simplifying the construction of the generator set and providing new possibilities for the management of the operation of the latter.

The invention is intended to meet this requirement, which is fulfilled by means of a system for the control and regulation of a generator set, comprising an alternator which is mechanically coupled to a drive motor, the alternator comprising a terminal box borne by a casing and containing electrical connections connected to the windings of the alternator, wherein the system comprises a controller part for controlling the generator set and a regulator part for regulating an output voltage of the alternator, the voltage regulator part being positioned outside the terminal box and solidly connected to the controller part of the generator set.

By “solidly connected”, it is understood that the voltage regulator part is secured to the controller part of the generator set, or to the same support, or is accommodated in the same housing as the latter, wherein said housing is different from a compartment which encloses the generator set as a whole.

Thanks to the invention, it is possible to reduce the size of the terminal box of the alternator, which is customarily designed to accommodate the connecting terminals and the voltage regulator. The closer spacing of the latter to the controller makes it possible to reduce the dimensions of the terminal box, thereby saving costs and reducing the footprint of the alternator, thereby facilitating its integration in the generator set. Moreover, the physical proximity of the controller and the regulator, for example within a single housing, facilitates cabling and provides scope for mutual data exchanges, thus delivering new possibilities for the optimization of the overall costs of the solution, while increasing its reliability and enhancing its maintenance.

The system according to the invention can deliver the functions which are conventionally associated with a voltage regulator and a controller on the generator set. These functions include the regulation of the output voltage of the alternator, the display of electrical, thermal and/or mechanical parameters on the generator set, and the electrical, thermal and mechanical protection of the generator set, in accordance with the read-out or calculated parameters.

Preferably, the controller part and the regulator part of the alternator (also described as the AVR) are accommodated in a single housing, which may or may not be secured to the alternator or the drive motor, and is preferably secured to a support which is separate from the alternator and the motor.

The controller part of the generator set and the voltage regulator part may comprise electronic circuit boards, for example at least two, if not three electronic circuit boards, of the printed-circuit type.

Preferably, the controller part of the generator set and the regulator part comprise at least one power board, one communication board, and one control board.

The power board may comprise power components for the supply of an excitation inductor coil of the alternator. The control board may comprise all or part of the digital components of the system, specifically the core processing elements, such as one or more microprocessors or microcontrollers. The power board may also comprise digital components, specifically those dedicated to the calculation of commands for the power components.

The system, for example the regulator part, may comprise at least one radiator, and preferably two, for the cooling of the power components which supply the excitation inductor coil of the alternator. The radiator or radiators are preferably accommodated in the housing.

The radiator or radiators are, for example, secured to the power board, preferably to the side of the power board which is arranged opposite the control board, where the power board and the control board are two separate boards accommodated in the same housing, as specified above.

The housing may comprise a hood which encloses the top end of the various boards and the above-mentioned radiator(s).

This hood may comprise an extension to the rear, which is substantially molded to the shape of the radiator or radiators, and is provided with air circulation vents on both the top and the sides. The hood is advantageously formed by the molding of a thermoplastic material.

The hood may be designed for snap-on attachment to a front element of the housing, comprising a front panel.

The system may comprise a user interface, which is preferably connected directly to the control board.

The user interface may comprise a display, for example of the LED or LCD type, of electrical, thermal and/or mechanical parameters on the generator set. The user interface may be located on a front surface of the system, for example the front panel of the above-mentioned housing. The user interface may comprise one or more control buttons. The buttons, which are not limited in respect of number, permit access to the various system parameters.

For example, the user interface may be configured such that the control button or buttons permit access to a parameter settings menu for the regulator part.

The accessible parameters for the regulator part are preferably selected from all or some of the following parameters:
stability of voltage regulation,
the voltage run-up ramp, as a function of the frequency of rotation of the generator set (U/f),
selection of the service frequency between 50 Hz, 60 Hz and, where applicable, any other frequency lower than 500 Hz, and
selection of the service voltage range, preferably up to 30 kV,
the excitation current and/or voltage,
the drive motor assistance function during load transients; accordingly, the regulator part may deploy one or more algorithms which are intended to assist the motor during load take-up or load-shedding phases.

Preferably, the regulator part controls the voltage of the alternator in accordance with a U/f law, where U is the output voltage of the alternator and f is its frequency of rotation, specifically to ensure the protection of the alternator against overheating when running under-speed. The interface may be equipped with light-emitting diodes, in order to notify the user of an operating mode of the generator set and/or of the electrical installation.

The various board(s) of the controller part and that (or those) of the regulator part are preferably interconnected by means of a junction board equipped with connectors, specifically of the PCI express type, or other types of local serial bus.

This junction board permits information exchanges between the controller part and the regulator part. It is possible that the junction board comprises no active components, and is preferably comprised of a printed circuit and bonding connectors.

As a variant, the various board(s) of the controller part of the generator set and that (or those) of the regulator part may be interconnected by other types of links, whether cabled or otherwise, without the presence of an additional board.

The junction board may be arranged perpendicularly to the other boards, and its connectors may cooperate with the printed circuit paths on these boards.

At least one of the boards may also comprise connectors for peripherals, specifically of the USB and/or the CAN bus type, and/or dedicated connectors for measurements of electrical, thermal and/or mechanical parameters on the generator set and/or on the network, specifically electrical parameters such as voltages and currents.

Preferably, a common physical input, also described as a port, can accommodate a serial bus, preferably a CAN bus (Controller Area Network in accordance with ISO standard 11898), or an MPU pick-up signal. The CAN bus can transmit information, for example using the j1939 protocol, thus permitting the delivery of information on, for example, the temperature of the motor coolant fluid, the oil pressure, the fuel level, the starter battery voltage, etc. The MPU pick-up is a magnetic pick-up arranged in the vicinity of a toothed wheel which is attached to the motor shaft, and which responds to the passage of each tooth, delivering a variable-frequency signal which is representative of the speed of rotation of the shaft. The regulator part thus receives, on the same port, a signal which may originate either from the CAN or from the MPU, and which is then decoded by means of software for the extraction of useful information therefrom.

The use of a single physical input for the CAN and the MPU provides an advantage in terms of compactness, associated with the reduction of connectors. Moreover, this arrangement permits greater flexibility in the manufacture of generator sets, permitting the use of a single system for sets of the CAN type and others of the MPU type, wherein the changeover may be effected by means of software only.

The controller part of the generator set may assume start-up and shutdown functions, specifically preheating, driving by the starter motor, ventilation prior to shutdown and shutdown, together with functions for the protection of the generator set, for example in the event of an excessive temperature in the coolant fluid.

Preferably, the system also delivers a function for the monitoring of an auxiliary alternator for the charging of the battery of the generator set, where provided, permitting the detection of a malfunction of the latter.

The boards and connectors are preferably configured in a compact arrangement, in order to reduce the footprint. Preferably, all the boards, with the exception of the junction board, are stacked one on top of another.

For example, the communication board is arranged between the power board and the control board. This increases the clearance between the power component or components mounted on the power board of the digital components mounted on the control board, thereby facilitating the cooling of the latter and reducing exposure to magnetic fields associated with high currents.

The system may comprise at least one board which is common to the controller part and the regulator part. For example, the communication board and/or the control board may be common to both parts.

The term “board common to the controller part and the regulator part” designates a board which simultaneously comprises components which contribute to the execution of the conventional functions of a controller, and components which contribute to the execution of the conventional functions of a regulator.

The board or boards common to the regulator part and the controller part of the generator set may be situated between the boards which are specific to the controller part or to the regulator part. This permits the minimization of the length of conduction paths, and facilitates the achievement of a compact structure.

Preferably, the connectors for peripherals and/or dedicated connectors for measurements of electrical, thermal and/or mechanical parameters on the generator set and/or on the network are situated on the common board or boards, and specifically on a single common board, for example the communication board, where applicable.

Information exchanges between the controller part and the regulator part also permit the deployment of a motor assistance strategy, based upon the calculation of the active power, in order to restrict dips and overshoots in the alternator voltage during load transients.

The motor assistance function may be deployed where the speed of the heat engine has already dipped, and its speed has fallen below a certain value.

The motor assistance function may also be applied immediately upon the application of a load and/or a variation in electric power at the alternator output.

The detection of a load variation associated with the observation of the electric power permits the anticipation of a drop in the motor speed, and measures can then be deployed for the effective restriction of this drop.

A further object of the invention is a generator set equipped with a control and regulation system according to the invention. The capacity of the generator set is preferably greater than or equal to 5 kW.

The invention will be better understood on reading the detailed description of a non-limiting exemplary embodiment thereof set out below, with reference to the attached drawing, in which:

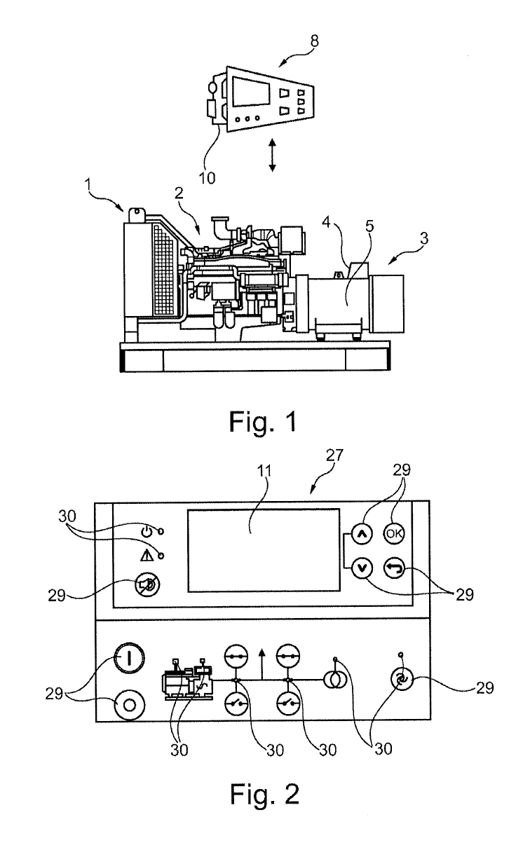

FIG. 1 shows a schematic representation of one example of a generator set according to the invention,

FIG. 2 shows an example of a user interface,

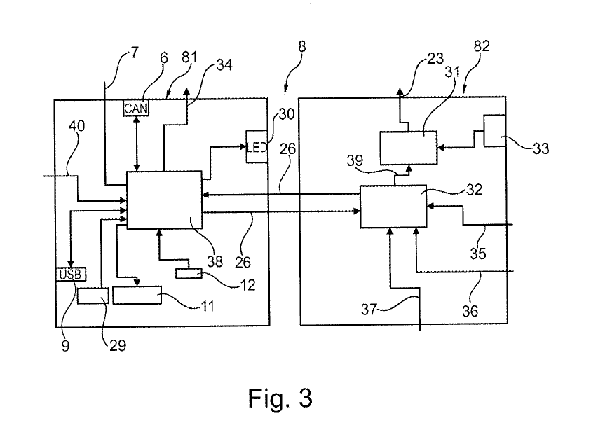

FIG. 3 shows an example of a system architecture according to the invention,

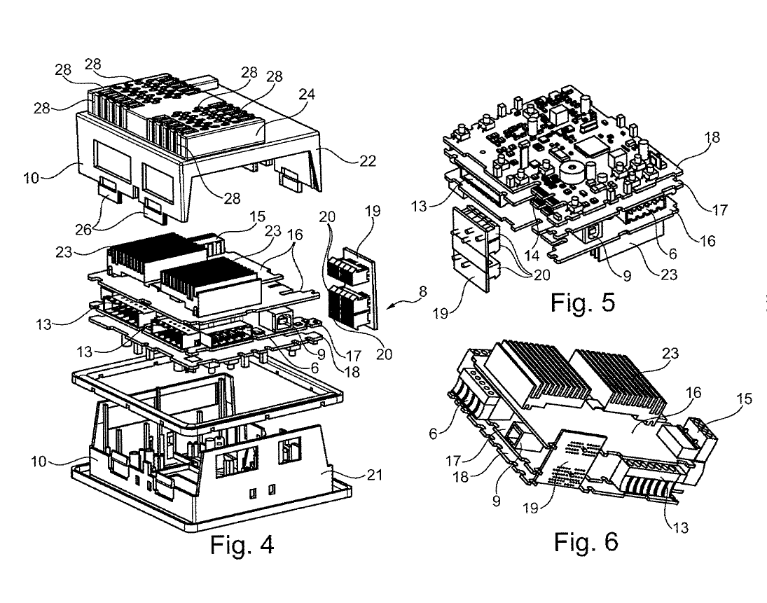

FIG. 4 shows an exploded view of a system according to the invention,

FIGS. 5 and 6 show separately, in perspective, the combination of printed circuit boards, viewed from different angles.

The generator set 1 represented in FIG. 1 comprises a heat engine 2 coupled to an alternator 3. The latter has a casing 5 provided with a terminal box 4, which accommodates the connection terminals to the excitation windings and the main inductor coil.

The generator set 1, according to the invention, is connected to a control and regulation system 8 which comprises a voltage regulator part and a unit controller part which are solidly interconnected and preferably, as illustrated in FIG. 4, accommodated in a single housing 10.

This housing 10 is situated in a different location from the terminal box 4, and may be secured to a frame which is remote from the alternator 3 and the motor 2.

An example of the architecture of the system 8 is illustrated in FIG. 3.

The system 8 comprises a controller part 81 of the generator set and a voltage regulator part 82.

The system 8 is supplied, for example, via the controller part 81, by means of an external source, for example from 8 to 35 V in d.c. current.

The controller part 81 of the generator set is preferably provided with a microcontroller 38 comprising a core processor, wherein the latter constitutes the main digital component of the system. Further microcontrollers may be added thereto, where applicable.

Analog 40 and digital 7 inputs of the microcontroller 38 may activate digital commands 34 for start-up, shutdown, the activation of relays and/or alarms, or for the direct control of components on the generator set 1, for example the starter, the preheating system, etc.

The analog inputs 40 can accommodate voltage sources ranging, for example, from 0 to 10 V, current sources ranging, for example, from 4 to 20 mA, may permit the connection of potentiometers and may receive direct information from sensors positioned at various points on the generator set 1, such as sensors for oil pressure, the coolant fluid temperature, and speed of rotation.

The system 8 has a user interface 27 comprising, as can be seen from FIG. 2, a display 11, LEDs 30, and control buttons 29 for the system 8.

The LEDs 30 permit a direct read-out of the operating state of the system 8, of the generator set 1, and of the connection between the generator set and an external electric grid.

In the example illustrated, the system 8 comprises USB 9 and CAN 6 connectors for peripherals. Other types of connectors for peripherals may be used, without departing from the scope of the present invention.

These connectors 9 and 6 permit, on the one hand, the reception of setpoint instructions from the user, for example via a computer and, on the other hand, the transmission of operating parameters to an external component and/or the updating of the internal software of the solution, more generally described as firmware.

In the example illustrated, the system 8 also comprises a connector 12, for example of the JTAG type, in order to facilitate debugging, although any other means for the execution of this function will fall within the scope of the present invention.

The regulator part 82 comprises a power electronic component 31, a core processor 32 comprising an electronic circuit, which is responsible for generating the command signals 39, whether analog or digital, on the power component 31, in order to ensure correct voltage regulation on the alternator 5 and, where applicable, one or more microprocessors for the respective execution of specific measuring, regulation and/or protection functions.

The power component 31 is comprised, for example, of a diode rectifier and a controlled chopper for the supply of the excitation inductor coil of the alternator 5 via a link 23. The latter delivers a d.c. current output, preferably up to 6 A in normal operation and up to 15 A for a few seconds, for example 10s.

The regulator part 82 is fully or partially controllable by the controller part, by means of digital signals 26 exchanged between the core processors of these two parts.

These signals 26, carried on the printed circuits of electronic circuit boards, where applicable, permit the exchange of information between the two parts 81 and 82, without the use of cumbersome links.

The regulator part 82 comprises connectors for the exchange of information with the alternator and the grid system, for example connectors designed respectively for the measurement of the output current 35 and voltage 36 of the alternator, and for the measurement of voltage 37 on the grid system.

The controller part 81 may, where applicable, execute the measurement of output currents 35 and voltages 36 of the alternator, together with voltages 37 on the grid system.

As a variant, the two parts may share a single core processor. In this case, commands may be transmitted from this core processor directly to the power components, in accordance both with information 35, 36, 37 originating from the alternator and the grid system, and from the analog 40 and digital 7 inputs.

The regulator part 82 is preferably compatible with different excitation systems 33, such as SHUNT, AREP and PMG excitation, wherein energy is tapped respectively from the output voltage of the alternator, the auxiliary windings of the alternator, and a permanent magnet generator. The regulator part 82 may be supplied electrically by at least one of these excitation systems 33.

The grid system and/or alternator voltages are, for example, three-phase voltages ranging from 90 to 530 V a.c., and the output current of the alternator is measured by current transformers, the secondary side of which is for example rated between 1 and 5 A a.c.

The regulator part preferably deploys one or more algorithms which are intended to assist the motor during load take-up or load-shedding phases.

Preferably, the regulator part controls the alternator voltage in accordance with a U/f law, where U is the output voltage of the alternator and f is its frequency of rotation, specifically to ensure the protection of the alternator against overheating when running under-speed.

For example, if the speed is 1,000 r.p.m. and the setpoint voltage is maintained at 400 V, the nominal value of the excitation current will then become very high. Likewise, as a result of this low speed of rotation, cooling of the alternator is reduced. Control of the alternator voltage in accordance with the U/f law permits the reduction of the setpoint voltage, and therefore of the excitation current, thus reducing the thermal energy to be dissipated. Overheating associated with the excitation current is prevented accordingly.

The system 8 may also comprise dedicated connectors, for example for the connection of a drive motor controller.

The regulator part 82 and the controller part 81 may be formed of printed electronic circuit boards 16, 17, 18, and a junction board 19, as illustrated in FIGS. 4 to 6.

The boards 16 to 19 are accommodated in a housing 10, which comprises a front part 21 and a rear hood 22, which may be secured to the front part 21, for example, by means of snap-on attachment, using the lugs 26.

The hood 22 is provided with an extension 24 to the rear, which covers the radiators 23 for the cooling of the power components carried by the surface 25 of the board 16 opposite the control board 18.

The radiators 23 may entirely cover the power components on this surface 25.

The extension 24 is perforated, and is provided with vents 28 for the circulation of air on both the top and sides.

The three boards 16, 17, 18 are arranged parallel to each other, and are interconnected by the junction board 19 which, in the example considered, is equipped with connectors 20, as can be seen more specifically in FIG. 4. The junction board 19 can only distribute low-power signals for the exchange of information between the boards 16, 17, 18, together with the internal power supplies of the system 8.

The board 16 for the regulator part 82 is located on the side of the rear hood 22 and the controller part 81 is located on the side of the front part 21. The front part 21 incorporates the user interface 27.

The power board 16, associated with the voltage regulator part 82, comprises the power electronic component and a connector 15, or possibly a plurality of dedicated connectors for the power supply of the SHUNT and/or AREP and/or PMG excitation systems, and for the power supply of the excitation inductor coil.

The communication board 17, located between the power board 16 and the control board 18, is common to the regulator part 82 and the controller part 81, accommodates the dedicated USB port 9 for parameter settings on the system, the CAN bus 6 and the dedicated connectors 13 for alternator and grid system voltage measurements, together with alternator current measurements.

As a variant, these dedicated connectors 15 for voltage and current measurements may be located, in whole or in part, on the power board 16 and/or on the control board 18.

The communication board 17 also comprises logic outputs and low-power analog signal inputs. These signals permit, for example, the monitoring of certain parameters on the generator set, such as the fuel level and the coolant fluid temperature.

The control board 18, which is also common to the two parts 81 and 82, is assigned to all command functions executed from the user interface 27 by means of the buttons 29, as well as to the display 11 and to the alarm function, for example a buzzer, where applicable.

The connection of these three boards 16, 17, 18 is achieved by means of the junction board 19 equipped with PCI express connectors 20 via the printed circuit conduction paths 14. This junction board 19 is arranged perpendicularly to the stack of three boards 16, 17, 18 and the PCI express connectors 20.

Preferably, the physical input corresponding to the CAN bus 6 (Controller Area Network in accordance with ISO standard 11898) can also receive the signal from a MPU pick-up. Accordingly, the user can connect both types of signals to this input at will. Selection is effected in the product configuration software.

The regulator part thus receives, on the same port, a signal originating from either the CAN or the MPU, and uses software for the decoding of this signal and the extraction of useful information therefrom.

Preferably, the controller part of the generator set also assumes functions for the start-up and shutdown of the generator set.

Preferably, the system also assumes a function for the monitoring of an auxiliary alternator for the charging of the battery of the generator set, where provided, permitting the detection of a malfunction of the latter.

Any other embodiment employing a larger or smaller number of electronic circuit boards falls within the scope of the present invention.

For example, the communication board 17 may be omitted. In this case, the connectors 6, 9, 13 carried by this board are distributed, for example, between the power board 16 and the control board 17.

Moreover, any other distribution of the above-mentioned functions between the various boards also falls within the scope of the present invention.

1.-19. (canceled)

20. A system for the control and regulation of a generator set, comprising an alternator which is mechanically coupled to a drive motor, the alternator comprising a terminal box borne by a casing and containing electrical connections connected to the windings of the alternator;
wherein the system comprises a controller part for controlling the generator set and a regulator part for regulating an output voltage of the alternator, the voltage regulator part being positioned outside the terminal box and solidly connected to the controller part of the generator set, wherein the controller part and the regulator part are accommodated in the same housing.

21. The system as claimed in claim 20, comprising a common physical input for the accommodation of a serial bus.

22. The system as claimed in claim 20, delivering a function for the monitoring of an auxiliary alternator for the charging of the battery of the generator set, permitting the detection of a malfunction of the latter.

23. The system as claimed in claim 20, wherein the controller part of the generator set assumes functions for the start-up and shutdown of the generator set.

24. The system as claimed in claim 20, wherein the regulator part deploys one or more algorithms which are intended to assist the motor during phases of transient loading.

25. The system as claimed in claim 20, wherein the regulator part controls the voltage of the alternator in accordance with a U/f law, where U is the output voltage of the alternator and f is its frequency of rotation, specifically to ensure the protection of the alternator against overheating when running under-speed.

26. The system as claimed in claim 20, wherein the regulator part comprises at least one radiator for the cooling of the power components which supply an excitation inductor coil of the alternator.

27. The system as claimed in claim 20, comprising a user interface.

28. The system as claimed in claim 27, wherein the user interface comprises a display of electrical, thermal and/or mechanical parameters on the generator set and one or more control buttons.

29. The system as claimed in claim 28, wherein the user interface is configured such that the control button or buttons permit access to a parameter settings menu for the regulator part.

30. The system as claimed in claim 29, wherein the accessible parameters for the regulator part are selected from all or some of the following parameters:
stability of voltage regulation,
the voltage run-up ramp, as a function of the frequency of rotation of the generator set (U/f),
selection of the service frequency between 50 Hz, 60 Hz and, where applicable, any other frequency equal to or lower than 500 Hz,
selection of a service voltage range,
the excitation current and/or voltage,
the drive motor assistance function during load transients.

31. The system as claimed in claim 20, wherein the controller part of the generator set and the regulator part comprise electronic circuit boards.

32. The system as claimed in claim 31, wherein the various board(s) of the controller part of the generator set and that (or those) of the regulator part are interconnected by means of a junction board equipped with connectors, specifically of the PCI express type.

33. The system as claimed in claim 32, wherein the junction board is arranged perpendicularly to the other boards, such that its connectors cooperate with the printed circuit paths on these boards.

34. The system as claimed in claim 31, wherein at least one of the boards comprises connectors for peripherals, specifically of the USB and/or the CAN bus type, and/or dedicated connectors for measurements of electrical, thermal and/or mechanical parameters on the generator set and/or on the network.

35. The system as claimed in claim 31, wherein the communication board is located between the power board and the control board.

36. The system as claimed in claim 31, comprising at least one board which is common to the controller part and the regulator part.

37. The system as claimed in claim 34, wherein the connectors for peripherals and/or the dedicated connectors for measurements of electrical, thermal and/or mechanical parameters on the generator set and/or on the network are situated on the common board or boards.

38. The system as claimed in claim 21, the serial bus being a CAN bus, or an MPU pick-up signal

39. A generator set equipped with a control and regulation system as defined in claim 20.

40. The generator set as claimed in claim 20, the capacity of the generator set being greater than or equal to 5 kW.
